(19) United States
(12) Patent Application Publication
(10) Pub. No.: US 2020/0219050 A1
(43) Pub. Date: Jul. 9, 2020

(54) MARKETPLACE FOR ACTIVE TRANSPORT COOLERS

(71) Applicant: Carrier Corporation, Palm Beach Gardens, FL (US)

(72) Inventor: Tony Spath, West Hartford, CT (US)

(21) Appl. No.: 16/649,850

(22) PCT Filed: Sep. 26, 2018
(86) PCT No.: PCT/US2018/052862

§ 371 Date: Mar. 23, 2020

Related U.S. Application Data
(60) Provisional application No. 62/563,761, filed on Sep. 27, 2017.

(51) Int. Cl. G06Q 10/08

(52) U.S. Cl. CPC G06Q 10/0832; G06Q 10/08345

(57) ABSTRACT

A method and system for providing cold transportation is disclosed. A method includes receiving a registration of a transportation provider on a digital marketplace. A method further includes verifying capabilities of the transportation provider and receiving a transportation request from a requestor. A method further includes making the transportation request available to multiple transportation providers. A method further includes receiving a claim request from a transportation provider, wherein the claim indicates a desire to fulfill the transportation request. A method further includes arranging for payment of the transportation request between the transportation provider and the requestor. The method is embodied in a digital marketplace.

### BACKGROUND

Exemplary embodiments pertain to the art of cooling systems. In particular, the present disclosure relates to a marketplace for transport coolers.

Food products benefit from being refrigerated and/or frozen. In particular, the growth rate of bacteria on some foods is significantly slowed down when the food is kept refrigerated at a temperature of 4 degrees Celsius (40 degrees Fahrenheit) or below. Frozen foods are generally kept below a temperature of approximately −18 degrees Celsius (0 degrees Fahrenheit). Keeping food below such temperatures can be of great importance for food safety, especially in “last mile” (delivery to a store or to a customer) situations.

### BRIEF DESCRIPTION

According to one embodiment, a method for providing cold transportation can comprise receiving a registration of a transportation provider on a digital marketplace; verifying capabilities of the transportation provider; receiving a transportation request from a requestor; making the transportation request available to multiple transportation providers; receiving a claim request from the transportation provider, wherein the claim indicates a desire to fulfill the transportation request; and arranging for payment of the transportation request between the transportation provider and the requestor; wherein the method is embodied in a digital marketplace.

In addition to one or more features described above, or as an alternative, further embodiments may include wherein the registration comprises information about cold transportation capabilities of the transportation provider.

In addition to features described above, or as an alternative, further embodiments may include the cold transportation capabilities include a capacity of a vehicle, and a temperature range of the vehicle.

In addition to features described above, or as an alternative, further embodiments may wherein the registration is confirmed via a unique identifier of a refrigeration unit operated by the transportation provider.

In addition to features described above, or as an alternative, further embodiments may include wherein information about cold transportation capabilities includes a periodic verification of the refrigeration unit.

In addition to features described above, or as an alternative, further embodiments may include wherein arranging for payment includes facilitating negotiation of a price between the transportation provider and the requestor.

In addition to features described above, or as an alternative, further embodiments may include wherein facilitating negotiation includes arranging an auction such that multiple transportation providers can each supply a bid and the requestor can select one transportation provider based on the bids of the multiple transportation providers.

In addition to features described above, or as an alternative, further embodiments may include wherein arranging for payment includes determining a price of the transportation based on a distance of the transportation, and time of day, using a predetermined algorithm.

In addition to features described above, or as an alternative, further embodiments may include wherein the predetermined algorithm further uses demand to determine a price of transportation.

In addition to features described above, or as an alternative, further embodiments may include wherein arranging for payment comprises: receiving payment information from the requestor; receiving account information from the transportation provider; and transferring payment from the requestor to the transportation provider upon completion of transportation services.

In addition to features described above, or as an alternative, further embodiments may include tracking a location of the transportation provider after receiving the claim request from the transportation provider.

According to one embodiment, a system can comprise a digital marketplace operable to execute on a computer processor and accessible via a mobile electronic device; wherein the digital marketplace is configured to: receive a registration of a transportation provider on a digital marketplace; verify capabilities of the transportation provider; receive a transportation request from a requestor; make the transportation request available to multiple transportation providers; receive a claim request from the transportation provider, wherein the claim indicates a desire to fulfill the transportation request; and arrange for payment of the transportation request between the transportation provider and the requestor.

In addition to features described above, or as an alternative, further embodiments may include wherein the registration comprises information about cold transportation capabilities of the transportation provider.

In addition to features described above, or as an alternative, further embodiments may include wherein the cold transportation capabilities include a capacity of a vehicle, and a temperature range of the vehicle.

In addition to features described above, or as an alternative, further embodiments may include wherein the registration is confirmed via a unique identifier of a refrigeration unit operated by the transportation provider.

In addition to features described above, or as an alternative, further embodiments may include wherein arranging for payment includes facilitating negotiation of a price between the transportation provider and the requestor.

In addition to features described above, or as an alternative, further embodiments may include wherein facilitating negotiation includes arranging an auction such that multiple transportation providers can each supply a bid and the requestor can select one transportation provider based on the bids of the multiple transportation providers.

In addition to features described above, or as an alternative, further embodiments may include wherein arranging for payment includes determining a price of the transportation based on a distance of the transportation, and time of day, using a predetermined algorithm.

In addition to features described above, or as an alternative, further embodiments may include wherein the predetermined algorithm further uses demand to determine a price of transportation.

In addition to features described above, or as an alternative, further embodiments may include wherein arranging for payment comprises: receiving payment information from the requestor; receiving account information from the transportation provider; and transferring payment from the requestor to the transportation provider upon completion of transportation services.

### BRIEF DESCRIPTION OF THE DRAWINGS

The following descriptions should not be considered limiting in any way. With reference to the accompanying drawings, like elements are numbered alike:

FIG. 1 is a flowchart illustrating the operation of one or more embodiments; and

FIG. 2 is a block diagram illustrating the use of one or more embodiments.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

As described above, food products can be healthier if they are maintained at a certain temperature, such as below −18 degrees Celsius for frozen foods or below 4 degrees Celsius for refrigerated foods. In certain communities, it may be difficult to find ways to transport foods from one location to another while maintaining the food at a safe temperature.

In one or more embodiments, a marketplace allows owners of refrigerated vehicles (“transportation providers”) to more easily market and provide their services to a large number of customers (“requestors”). Thereafter, requestors can access the marketplace to access the marketed cold transportation capabilities of transportation providers. Both transportation providers and requestors thus receive benefits of such a service.

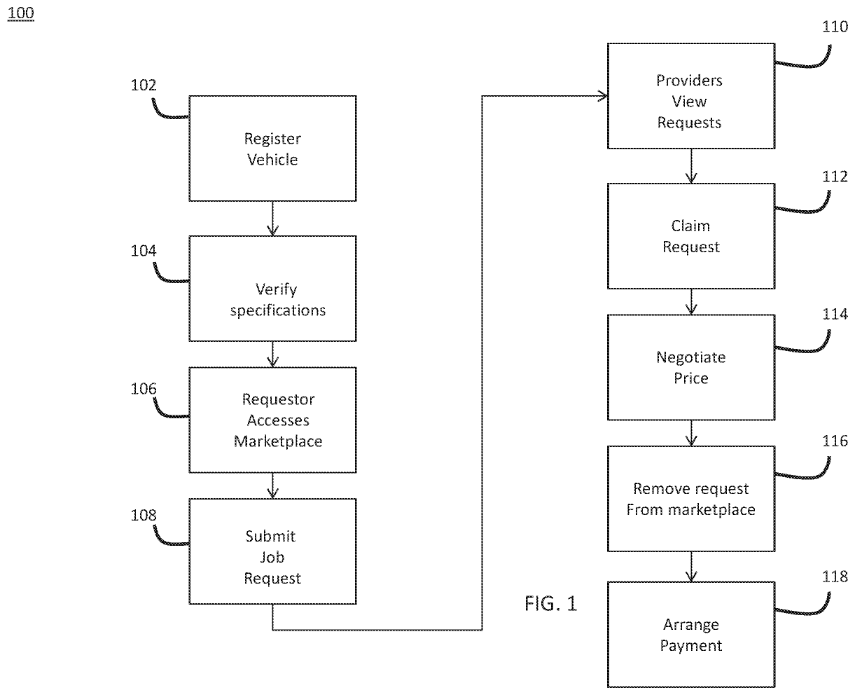

A flowchart illustrating method 100 is presented in FIG. 1. Method 100 is merely exemplary and is not limited to the embodiments presented herein. Method 100 can be employed in many different embodiments or examples not specifically depicted or described herein. In some embodiments, the procedures, processes, and/or activities of method 100 can be performed in the order presented. In other embodiments, one or more of the procedures, processes, and/or activities of method 100 can be combined or skipped. In one or more embodiments, method 100 is performed by a processor as it is executing instructions.

An owner or operator of a vehicle capable of cold transportation (transportation provider) registers the vehicle at a digital marketplace operating one or more embodiments (block 102). The registration can involve the entry of a variety of different information. For example, the capacity of the transportation and the specifications of the transportation (e.g., how cold the transportation can get and for how long it remains cold) can be input.

In some embodiments, some of these specifications can be verified (block 104). The verification can take place in one of a variety of different manners. For example, a vehicle capable of cold transportation can have a serial number for the refrigeration unit of the vehicle. Because the serial number is unique for each model, the specifications of the refrigeration unit could be collected using just the serial number and model number of the refrigeration unit. In some embodiments, a manufacturer of a refrigeration unit can provide a unique identifier that is associated with the specifications of the refrigeration unit and/or vehicle capable of cold transportation.

In some embodiments, there can be periodic verification of the refrigeration unit and/or vehicle capable of cold transportation. At a predetermined time interval (e.g., every six months or every 12 months), there can be a request sent to the owner/operator of the vehicle capable of cold transportation. Thereafter, the owner/operator confirms that the refrigeration unit is working as intended and within specification. The confirmation can occur in one of a variety of different manners. For example,

Entities that desire cold transportation (a requestor) access the marketplace (block 106). The access can be in one of a variety of different methods. In some embodiments, the marketplace can be accessible through the Internet via a web browser. In some embodiments, an app accessible via a mobile electronic device (such as a tablet, smartphone, laptop, e-reader, and the like) can be used to access the marketplace.

The requestor can enter in one or more requests for transportation (block 108). The request can include various information, such as an origin, a destination, a size request (e.g., how many space the transported material will occupy), a desired pickup time, a desired delivery time, a desired temperature (e.g., refrigerated goods or frozen goods or both), and the like.

Once the request is on the marketplace, transportation providers are able to view the requests (block 110). If they see a request that they want to fulfill, they can claim the request (block 112).

In some embodiments, the cost of the service can be negotiated at this time (block 114). In some embodiments, the cost can be set by an algorithm that takes into account the distance traveled, the size of the vehicle needed, the time of day, demand for transportation services, and the like. In such a manner, both the requestor and the transportation provider can be made aware of the price prior to starting services.

In some embodiments, an auction of sorts can take place at this time. Multiple transportation providers can each supply a bid to the requestor. After a set period of time (e.g., a predetermined time before the transportation is to begin), the requestor can select a transportation provider to provide their services. In some embodiments, the requestor can input a desired price at block 108. In such a manner, transportation providers can ignore requests that are below a threshold that they are willing to pay.

After the request is accepted, the request becomes no longer viewable to other transportation providers (block 116). The transportation provider will then fulfill the transportation request by proceeding to the origin at the requested time and delivering the products to the destination. After claiming a request, a position of the transportation provider can be tracked. The tracking can occur via an app on a mobile electronic device, such as the same app used to view the request. In such a manner, it can be automatically determined if and when the transportation request is fulfilled. In some embodiments, a requestor can track a cold transportation vehicle, both before the food has been picked up and while the food is being transported. The tracking can occur via the app. The app used by the cold transportation provider can utilize global navigation satellite capabilities of the smartphone or other electronic device to track the location of the vehicle, constantly updating the app such that the requestor can view the location of the vehicle using his own smartphone or other electronic device.

After the delivery is completed, payment is made through the app (block 118). In some embodiments, before requesting transportation services, the requestor creates an account that includes payment information. Transportation companies can also create an account that includes payment information. The payment information can be in the form of a debit card or credit card that the requestor enters and is kept on file. In some embodiments, a requestor can make a cash or check deposit to a specific account that is tracked and maintained by an entity providing the marketplace services. Thereafter, upon completion of the delivery task, money is removed from the requestor's account (e.g., the account maintained by the entity providing the marketplace services or the debit/credit card previously entered by the requestor) and placed in the transportation company's account. In some embodiments, a transportation company can submit bank information to the entity providing the marketplace services. Thereafter, upon completion of the services, money is transferred to the bank. In some embodiments, upon completion of the services, money can be credited to an account of the transportation company. Thereafter, the transportation company can request the money at a later time.

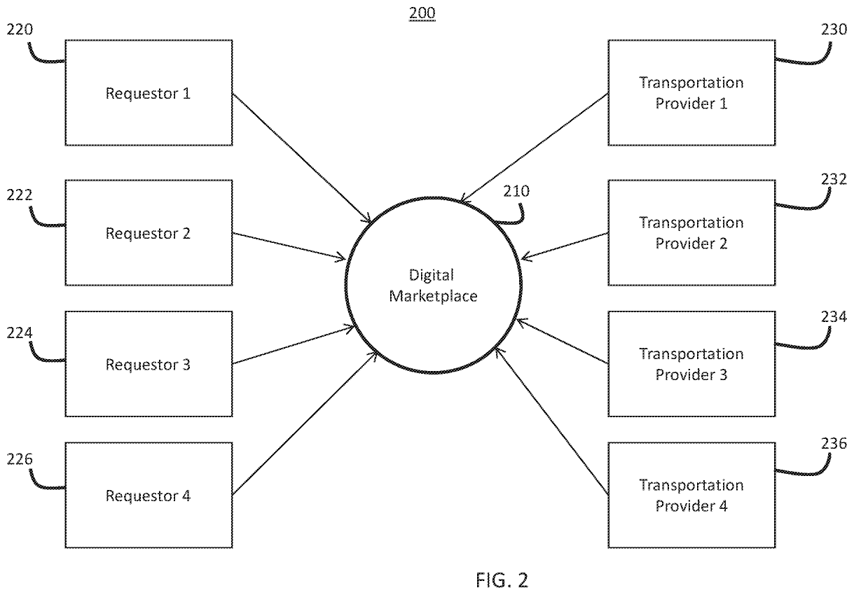

Referring to FIG. 2, a block diagram is shown illustrating the relationship between requestors and transportation providers in a system 200. Digital marketplace 210 is the marketplace described above which facilitates a connection between requestors and transportation providers.

Four requestors 220, 222, 224, and 226 are illustrated as accessing digital marketplace 210. As described above with respect to FIG. 1, each of the requestors can place a transportation request on digital marketplace 210. While only four requestors are shown in FIG. 2, it should be understood that there are no limits to the number of requestors who can access digital marketplace 210.

Four transportation providers 230, 232, 234, and 236 are illustrated as accessing digital marketplace 210. As described above with respect to FIG. 1, each of the transportation providers can bid on or fulfill a transportation request on digital marketplace 210. While only four transportation providers are shown in FIG. 2, it should be understood that there are no limits to the number of requestors who can access digital marketplace 210.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method for providing cold transportation comprising:
receiving a registration of a transportation provider on a digital marketplace;
verifying capabilities of the transportation provider;
receiving a transportation request from a requestor;
making the transportation request available to multiple transportation providers;
receiving a claim request from the transportation provider, wherein the claim indicates a desire to fulfill the transportation request; and
arranging for payment of the transportation request between the transportation provider and the requestor; wherein the method is embodied in a digital marketplace.

2. The method of claim 1 wherein:
the registration comprises information about cold transportation capabilities of the transportation provider.

3. The method of claim 2 wherein:
the cold transportation capabilities include a capacity of a vehicle, and a temperature range of the vehicle.

4. The method of claim 2 wherein the registration is confirmed via a unique identifier of a refrigeration unit operated by the transportation provider.

5. The method of claim 2 wherein information about cold transportation capabilities includes a periodic verification of the refrigeration unit.

6. The method of claim 1 wherein arranging for payment includes facilitating negotiation of a price between the transportation provider and the requestor.

7. The method of claim 5 wherein facilitating negotiation includes arranging an auction such that multiple transportation providers can each supply a bid and the requestor can select one transportation provider based on the bids of the multiple transportation providers.

8. The method of claim 1 wherein arranging for payment includes determining a price of the transportation based on a distance of the transportation, and time of day, using a predetermined algorithm.

9. The method of claim 8 wherein the predetermined algorithm further uses demand to determine a price of transportation.

10. The method of claim 1 wherein arranging for payment comprises:
receiving payment information from the requestor;
receiving account information from the transportation provider; and
transferring payment from the requestor to the transportation provider upon completion of transportation services.

11. The method of claim 1 further comprising:
tracking a location of the transportation provider after receiving the claim request from the transportation provider

12. A system for providing cold transportation comprising:
a digital marketplace operable to execute on a computer processor and accessible via a mobile electronic device;
wherein the digital marketplace is configured to:
receive a registration of a transportation provider on a digital marketplace;
verify capabilities of the transportation provider;
receive a transportation request from a requestor;
make the transportation request available to multiple transportation providers;
receive a claim request from the transportation provider, wherein the claim indicates a desire to fulfill the transportation request; and
arrange for payment of the transportation request between the transportation provider and the requestor.

13. The system of claim 12 wherein:
the registration comprises information about cold transportation capabilities of the transportation provider.

14. The system of claim 13 wherein:
the cold transportation capabilities include a capacity of a vehicle, and a temperature range of the vehicle.

15. The system of claim 13 wherein the registration is confirmed via a unique identifier of a refrigeration unit operated by the transportation provider.

16. The system of claim 12 wherein arranging for payment includes facilitating negotiation of a price between the transportation provider and the requestor.

17. The system of claim 16 wherein facilitating negotiation includes arranging an auction such that multiple transportation providers can each supply a bid and the requestor can select one transportation provider based on the bids of the multiple transportation providers.

18. The system of claim 12 wherein arranging for payment includes determining a price of the transportation based on a distance of the transportation, and time of day, using a predetermined algorithm.

19. The system of claim 18 wherein the predetermined algorithm further uses demand to determine a price of transportation.

20. The method of claim 12 wherein arranging for payment comprises:
receiving payment information from the requestor;
receiving account information from the transportation provider; and
transferring payment from the requestor to the transportation provider upon completion of transportation services.
